(19) United States
(12) Patent Application Publication
(10) Pub. No.: US 2017/0254915 A1
(43) Pub. Date: Sep. 7, 2017

(54) EARTH SURVEYING WITH TWO OR MORE MARINE VEHICLES FOR IMPROVED DRILLING APPLICATIONS

(71) Applicant: Liquid Robotics Oil and Gas LLC, Houston, TX (US)

(72) Inventors: Sudhir Pai, Houston, TX (US); Benny Poedjono, Sugar Land, TX (US)

(21) Appl. No.: 15/061,842

(22) Filed: Mar. 4, 2016

(51) Int. Cl. G01V 3/165; E21B 47/00; E21B 47/022; G01V 3/40; G01V 3/26

(52) U.S. Cl. CPC G01V 3/165; G01V 3/40; G01V 3/26; E21B 47/02216; E21B 47/0001

(57) ABSTRACT

Methods and apparatuses for geophysical surveying are disclosed. In one embodiment, a vehicle may obtain magnetic measurements in a location around a drilling site while a marine vehicle maintains an approximately stationary position nearby. The magnetic measurements from the two vehicles may be used to calculate a localized magnetic crustal field. The localized magnetic crustal field may be used to calculate a geomagnetic reference field that may be used to calculate and/or adjust wellbore position with improved accuracy.

### CROSS-REFERENCE TO RELATED PATENT APPLICATIONS

This application is related by subject matter to U.S. patent application Ser. No. 14/024,935 to Pal et al. filed on Sep. 12, 2013 and entitled “Earth Surveying for Improved Drilling Applications,” which is hereby incorporated by reference in its entirety.

### BACKGROUND

Wellbore position accuracy ensures successful drilling at a drilling site to a geological target, such as an underground reservoir of fluids including oil. Magnetic surveying of the area near the drilling site may improve an operator's ability to safely reach the geological target. Well placement by Measurement While Drilling (MWD) uses the direction of Earth's geomagnetic field as a natural reference direction. To compute the azimuth of the bottom hole assembly (BHA), the MWD tool takes a measurement of the magnetic field and the directional driller compares the measurement with the geomagnetic reference field. This requires accurate knowledge of the geomagnetic reference field direction and strength in the wellbore to provide an accurate position.

The state of the art for extracting crustal field in offshore locations involves collecting magnetic data for a potential drill site by airplane, called aeromagnetic survey, and then correcting the aeromagnetic survey by removing a disturbance field measured at an on shore base station. Unfortunately, this technique merely provides a rough estimate of the geomagnetic reference field and is limited by the distance between the on-shore base station and the location of the aeromagnetic survey. The distance between onshore base station and the measured offshore survey could exceed more than 200 km which will produce errors in the geomagnetic reference field and affect wellbore accuracy, especially when the magnetic disturbance at the off-shore survey location is not the same as the magnetic disturbance at the on-shore base station location.

### SUMMARY

The present systems, apparatuses and methods provide a solution to inaccurate or roughly estimated geomagnetic reference fields and provide more accurate measurements, such as for use during drilling into underground reservoirs. By utilizing two or more autonomous marine vehicles (AMVs), a crustal field component can be more accurately extracted, and thus the geomagnetic reference field more accurately defined. In one embodiment, one relatively stationary AMV may perform a tight radius maneuver that results in a virtually stationary base station AMV that records a disturbance field, and a second or more roving AMVs or Airborne Vehicle (AV) execute grid paths through an area to collect magnetic data. By subtracting the disturbance field collected from base station AMV to roving AMV or AV, then the crustal field can be accurately extracted.

Some embodiments of the present system comprise a first vehicle comprising a first magnetic measurement device, the first magnetic measurement device configured to obtain a first magnetic measurement below a surface level wherein the first magnetic measurement device is attached to the first vehicle, and wherein the first vehicle is configured to monitor a first magnetic field at a first location. In some embodiments, the system comprises a second vehicle comprising a second magnetic measurement device, the second magnetic measurement device configured to obtain a second magnetic measurement below a surface level wherein the second magnetic measurement device is attached to the second vehicle, and wherein the second vehicle is configured to monitor a second magnetic field at a second location. Some embodiments comprise a control system configured to provide the first vehicle and the second vehicle with data to control at least one of speed, heading, and waypoints. In some embodiments, the system comprises a processing system configured to receive the first magnetic measurement and the second magnetic measurement, wherein the processing system is further configured to calculate a localized magnetic crustal field based, at least in part, on the received first and second magnetic measurements by subtracting the second magnetic field measurement of the second magnetic measurement device from the first magnetic field measurement of the first magnetic measurement device.

In some embodiments, the processing system is further configured to generate a geomagnetic reference field based, at least in part, on the localized magnetic crustal field. In some embodiments, at least one of the first vehicle and second vehicle comprises at least one of a meteorological, an oceanographic, and a bathymetric sensor. Some embodiments of disclosed control system further comprise a guidance system configured to provide waypoints along a grid pattern to the first vehicle. And in some embodiments, the processing system is configured to transmit the first and second magnetic measurements in real-time.

In some embodiments, the magnetic measurement device of the second vehicle is attached to the second vehicle by a tow wire. And in some embodiments, the second vehicle further comprises at least one of a meteorological, an oceanographic, and a bathymetric sensor. Some embodiments of the second vehicle are configured to transmit the magnetic measurements in real-time. Some embodiments of the processing system are further configured to perform the steps of: calculating a main field; calculating a magnetic disturbance field; and calculating the localized magnetic crustal field based on the main field and the magnetic disturbance field. A main field may refer to a contribution primarily originating in the Earth's core and generally changes slowly on time scales of months to years. A crustal field may refer to a local crustal anomaly or crustal bias caused by magnetic minerals in the Earth's crust. A magnetic disturbance field may refer to a field caused by electric currents in near-Earth space due to solar activities, and by corresponding mirror-currents induced in the Earth and oceans. The disturbance field generally varies on time scales of seconds to days. Most of the variation at high latitudes occurs at periods of minutes to hours. All of these three contributions can be taken into account when computing an accurate geomagnetic reference field for the well bore position, and the improved magnetic measurements described herein generally refer to improvements in determining a contribution by the disturbance field.

One embodiment of the present apparatuses comprises a memory and a processor coupled to the memory, wherein the processor is configured to execute the steps of: receiving, from a first vehicle at a first location, a first set of magnetic field measurements corresponding to an area, wherein the magnetic field corresponds to measurements below a surface level; receiving, from a second vehicle at an approximately stationary second location, a second set of magnetic field measurements for the second location, wherein the magnetic field corresponds to measurements below a surface level, and wherein the area is in the vicinity of the second location; and calculating a localized magnetic crustal field based on the received first set of magnetic field measurements by subtracting the second set of magnetic field measurements from the first set of magnetic field measurements.

The foregoing has outlined rather broadly certain features and technical advantages of some embodiments of the disclosure in order that the detailed description that follows may be better understood. Additional features and advantages will be described hereinafter that form the subject of the claims. It should be appreciated by those having ordinary skill in the art that the specific embodiments disclosed may be readily utilized as a basis for modifying or designing other structures for carrying out the same or similar purposes. It should also be realized that such equivalent constructions do not depart from the spirit and scope of the invention as set forth in the appended claims. The novel features that are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the disclosure.

### BRIEF DESCRIPTION OF THE DRAWINGS

For a more complete understanding of the disclosed system and methods, reference is now made to the following descriptions taken in conjunction with the accompanying drawings.

FIG. 1 is a perspective view of a marine vehicle with a towed magnetic measurement device according to one embodiment of the disclosure.

FIGS. 2-6 illustrate various configurations for first and second vehicles to be used in calculating a geomagnetic reference field for supporting a drilling site according to some embodiments of the disclosure.

FIG. 7 is a flow chart illustrating a method of calculating a geomagnetic reference field that may be used by a directional driller according to one embodiment of the disclosure.

FIG. 8 is a map illustrating division of a region for scanning into sub-regions with different densities according to one embodiment of the disclosure.

### DETAILED DESCRIPTION

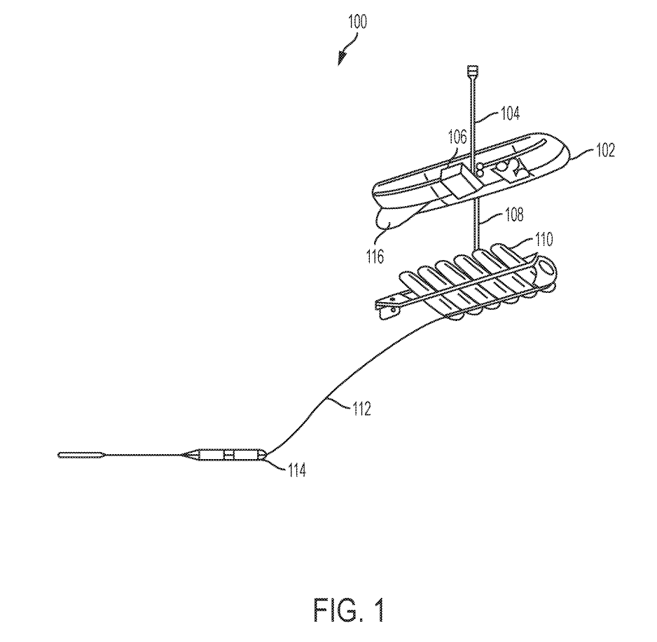

FIG. 1 is a perspective view of a marine vehicle with a towed magnetic measurement device according to one embodiment of the disclosure. A marine vehicle 100 may include a hull 102, a mast assembly 104, and a payload section 106. The payload section 106 may include, for example, a processing system coupled to an antenna on the mast assembly 104. A sub 110 may be attached to the hull 102 by an umbilical cord 108. The umbilical cord 108 may include cables to facilitate power transmission and communications between the processing system in the payload section 106 with electronic devices on sub 110. A magnetic measurement device 114, such as a magnetometer and/or the like, may be attached to sub 110 by a tow wire 112. The magnetic measurement device 114 may also be directly attached to hull 102 by a tow wire or mounted to hull 102. The magnetic measurement device 114 may include magnetometers for scientific seaborne applications, bi-axial horizontal and/or vertical magnetometer systems, and/or automated true-north tri-axial magnetometer systems. Tow wire 112 may likewise facilitate power transmission and communications between the processing system in the payload section 106 and the magnetic measurement device 114. Marine vehicle 100 may have a magnetic signature that been reduced to a negligible effect on magnetic measurements obtained by the magnetic measurement device 114 by designing an optimum spacing of tow wire 112. In some embodiments, marine vehicle 100 may be constructed entirely of non-magnetic materials. Additional details regarding the marine vehicle 100 are described in U.S. Pat. No. 7,371,136, which is incorporated by reference in its entirety.

Hull 102 may include solar panels (not shown) for generating power and a battery (not shown) in payload section 106 for storing power from the solar panels, to allow twenty-four hour operation of marine vehicle 100. The solar panels and battery may be configured to keep marine vehicle 100 in operation for approximately two to three weeks, or longer.

A rudder 116 on hull 102 may be controlled by the processing system to navigate marine vehicle 100 near a drilling site for obtaining magnetic measurements of a magnetic field. For example, the processing system may control rudder 116 to navigate marine vehicle 100 in a grid search pattern around the drilling site. In some embodiments, the processing system may receive commands from a remote location, such as the drilling site or magnetic observatory, instructing the marine vehicle to proceed to a particular destination and control rudder 116 appropriately. Payload section 106 may be fitted with a global positioning system (GPS) receiver to provide accurate or improved location information to the processing system.

In some embodiments, the processing system may obtain magnetic field measurements from magnetic measurement device 114 and store or transmit the magnetic field measurements. The magnetic field measurements may be tagged with location information from the GPS receiver. If the measurements are stored by the processing system, marine vehicle 100 may later be retrieved and the data downloaded from a memory of the processing system. If the measurements are transmitted, the processing system may include a wireless transmitter configured to transmit the magnetic measurements to a remote location, such as to a nearby magnetic observatory or the drilling site.

In some embodiments, payload section 106 may also be loaded with additional sensor devices to provide a suite of one or more services including, but not limited to, meteorological, oceanographic, bathymetric, deep water data harvesting from subsea structures and seabeds, hydrocarbon seep mapping, turbidity measurements, marine mammal monitoring, source signature processing and water column profiling. In some embodiments, magnetic surveying may be performed in combination with a geophysical survey.

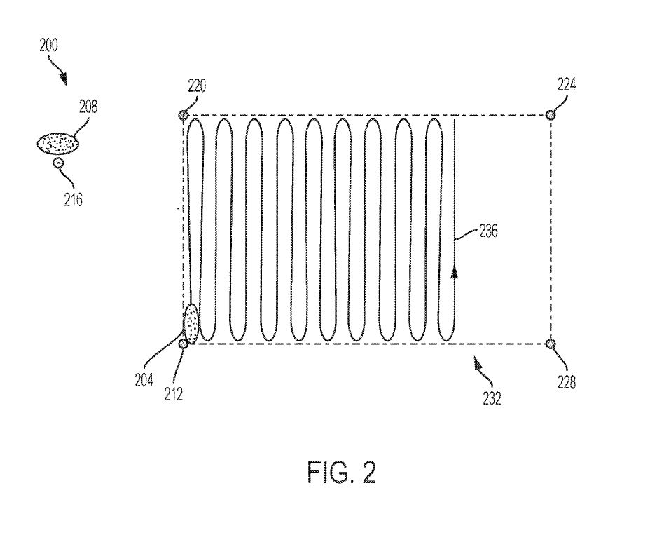

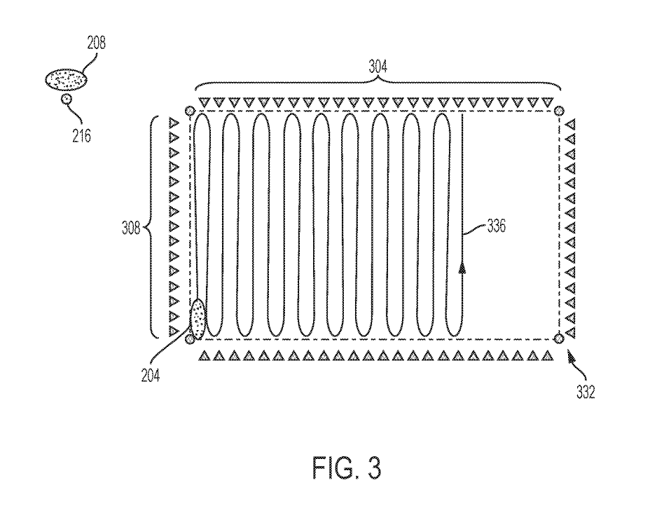

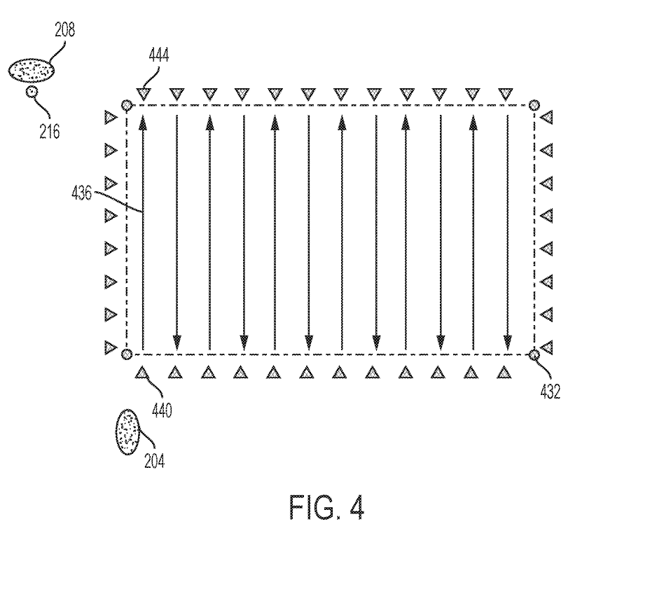

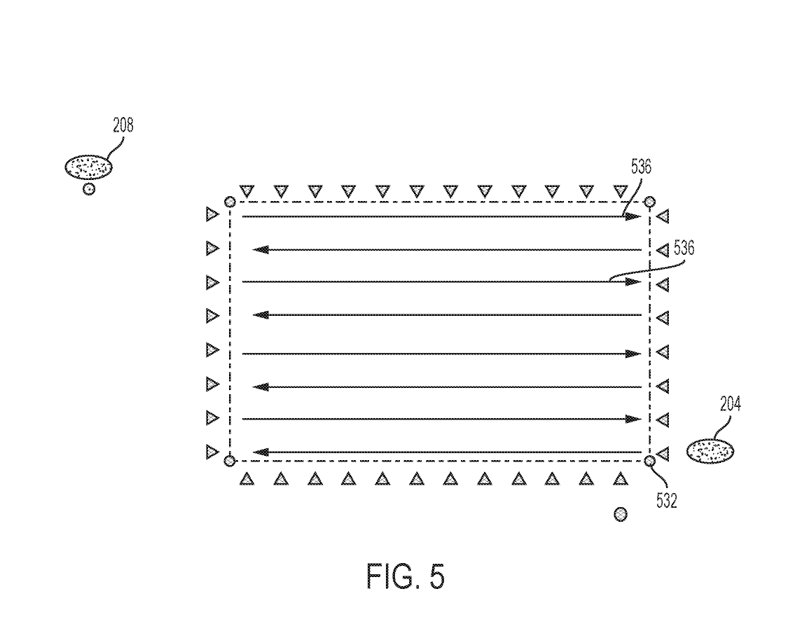

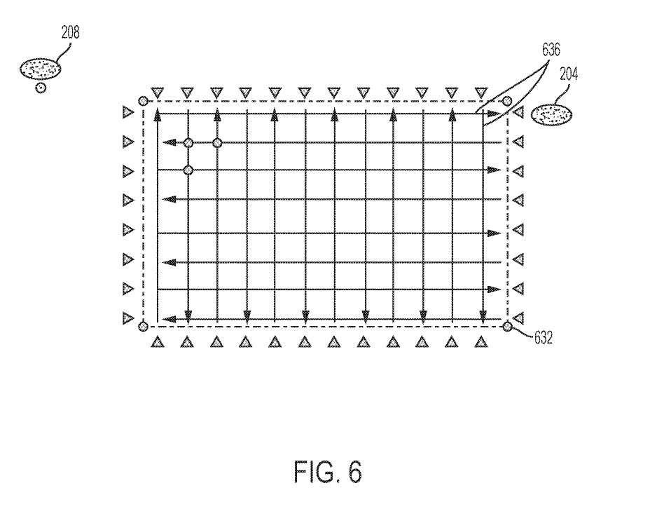

The vessel 100 illustrated in FIG. 1 may be used to perform magnetic measurements in a localized area with higher precision and accuracy than other conventional techniques. Further, multiple vessels like the vessel 100 may be operated and measurements from both vessels used to improve upon the accuracy and/or precision available with a magnetic measurements available from a single vessel. FIG. 2, FIG. 3, FIG. 4, FIG. 5, and FIG. 6 are illustrations of operation of two or more vessels for performing magnetic measurements. A magnetic measurement system 200 may include a first vehicle 204 and a second vehicle 208. In some embodiments, either one or both vehicles 204 and 208 include a first magnetic measurement device and a second magnetic measurements device, respectively. Either one or both of the first and second magnetic measurement devices may be configured to obtain magnetic measurement below a surface level. For example, a first vehicle 204 may be configured to monitor a first magnetic field at a first location (e.g., location 212) and second vehicle 208 is configured to monitor a second magnetic field at a second location (e.g., location 216). A control system (not shown) may provide vehicles 204 and 208 with data to control at least one of speed, heading, and waypoints. The control system may be part of one of the vehicles 204 and 208, for example, as part of the payload section 106 of a vehicle as illustrated in FIG. 1. In some embodiments, the control system may be part of an aerial vehicle or a remote control station that is remote from the first and/or second locations, e.g., an on shore base station. When external from the vehicle, the control system may communicate signals between the control system and the first and/or second vehicles wirelessly, either in real time or at designated synchronization times, such as periodic or predetermined times.

In some embodiments, the control system may be programmed prior to deployment of a vehicle (e.g., vehicle 204 or 208) with specific headings, speeds, and/or times to guide the vehicle. For example, the control system may be configured to be programmed prior to deployment with way points marked by either positioning system coordinates, such as global positioning system (GPS) coordinates or GLONASS coordinates, or deployed beacons such that the control system may guide the path of the vehicle to pass the programmed way points. In some embodiments, at least one of the heading, speed, time, and way points may be received by the control system in real time, near real time, or as a remote data load. In some embodiments, the control system may receive the at least one of the heading, speed, time, and way points via antennas.

FIGS. 2-6 illustrate various embodiments of the present systems and the paths that a first vehicle (e.g., 204) may travel in collecting magnetic measurements. In one mode of operation illustrated in FIG. 2, the control system may configure the first vehicle 204 to travel within a bounding geometry, such as the bounding box 232 defined by locations 212, 220, 224, and 228. The control system may provide GPS coordinates or relative positions of the edges defining bounding geometry 232 in the form of headings and distances. The first vehicle 204 may then travel within the bounding geometry 232 taking magnetic measurements on its path, as illustrated by path 236. The first vehicle 204 may navigate with reference to positioning system coordinates, magnetic compass headings, speed, dead reckoning, inertial navigation, and/or the like. The second vehicle 208 is configured to monitor a second magnetic field at a second location (e.g., location 216). The second location can be position anywhere around or inside the bounding geometry 232, 332, 432 532 and 632.

FIG. 3 illustrates an embodiment where the vehicle operates within a bounding geometry 332 defined by multiple points along an East-West axis, e.g., set 304, and multiple points along a North-South axis, e.g., set 308. One benefit of this embodiment is that the bounding box for the first vehicle 304 is defined with more granularity such that the path 336 of the first vehicle is better defined. In some embodiments, the point sets 304 and 308 are not aligned along an axis and conform to the area within the bounding geometry 332 that is to be measured. For example, point sets 304 and 308 may define an area around land, hazards, or areas that are not necessary for mapping. This additional particularity may be helpful for more efficient measurements and measurements in difficult geographies.

In another mode of operation, depicted in FIG. 4, first vehicle 204 may follow a path 436 that is defined by waypoints 440 and 444, while taking magnetic measurements along a path 436 inside area 432. FIG. 4 illustrates path 436 making North-South and South-North runs between waypoints. FIG. 5 illustrates conducting East-West and West-East runs on path 536 in area 532. In some embodiments, such as that shown in FIG. 6, a combination of paths such as path 436 from FIG. 4 and path 536 from FIG. 5 may provide comprehensive coverage of the magnetic field for the area being observed, e.g., within area 632. Path 636 in FIG. 6 is a combination of paths 436 and 536 from FIGS. 4 and 5, respectively. The embodiments illustrated in FIGS. 2 through 6 are not limiting, but are merely exemplary embodiments of how the first vehicle, e.g., 204, may traverse an area where a localized magnetic field is to be determined. By efficiently traversing and measuring the area, e.g., area 632, the magnetic measurements may be used to produce an extremely accurate geomagnetic reference field as described in more detail below.

In the depicted embodiment, vehicles 204 and 208 are both marine vehicles, such as, for example, the vehicle 100 depicted in FIG. 1. However, in some embodiments, vehicle 204 may be, for example, an airplane, boat, satellite, submarine, or drone that is configured to take magnetic measurements. In the depicted embodiment, the first and/or the second magnetic measurements are below a surface level, but may also be measured from above or at a surface level. In some embodiments, either or both vehicles 204 and 208 may be marine vehicles.

A magnetic measurement system may include a processing system to receive the first magnetic measurement and the second magnetic measurement from equipment on the same or different vessels. The processing system may be configured to calculate a localized magnetic crustal field based, at least in part, on a received first magnetic measurement (e.g., a magnetic measurement measured by vehicle 204) and a received second magnetic measurement (e.g., the magnetic measurement measured by vehicle 208). In some embodiments, the processing system is configured to calculate the localized magnetic crustal field by subtracting the second magnetic field measurement from vehicle (e.g., vehicle 208) from the first magnetic field measurement from vehicle (e.g., vehicle 204). This calculation may provide the localized magnetic crustal field at the location of vehicle (e.g., location 212) where the first magnetic field measurement was taken. The localized magnetic field may also be calculated at the location of the second vehicle (e.g., vehicle 208 at location 216) by subtracting the first magnetic field measurement from the second magnetic field measurement (e.g., the magnetic measurement measured by vehicle 204). The processing system may be further configured to generate a geomagnetic reference field based, at least in part, on the localized magnetic crustal field. In some embodiments, the processing system is part of a payload on a vehicle, e.g., payload 106 of FIG. 1. In some embodiments, the processing system is coupled to vehicle 204 or vehicle 208. Alternatively, the processing system may be located remotely on a satellite, ship, airplane, or on shore where the geomagnetic reference field calculation may be performed.

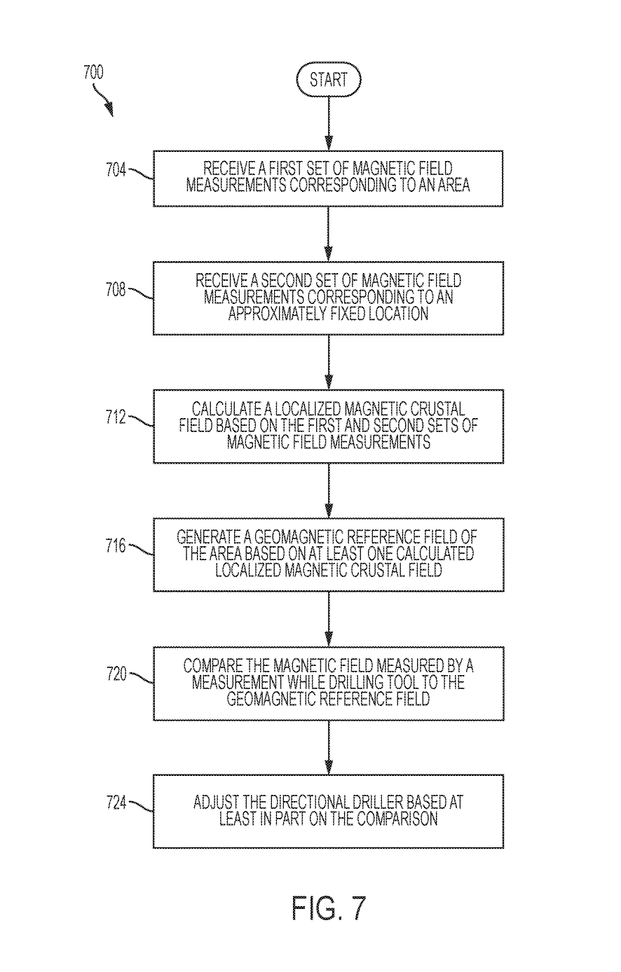

Turning now to FIG. 7, one method 700 begins at block 704 receiving a first set of magnetic field measurements corresponding to an area from a first vehicle at a first location at, near, or within the area wherein the magnetic field corresponds to measurements below a surface level. Then, at block 708, the method may include receiving a second set of magnetic field measurements for the second location from a second vehicle at an approximately stationary second location, wherein the magnetic field corresponds to measurements below a surface level, and wherein the area is in the vicinity of the second location. Next, at block 712, the method may include calculating a localized magnetic crustal field based on the received first set of magnetic field measurements by subtracting the second set of magnetic field measurements from the first set of magnetic field measurements. In some embodiments, the step of calculating a localized magnetic crustal field at block 712 may include the steps of calculating a main field; calculating a magnetic disturbance field; and/or calculating the localized magnetic crustal field based on the main field and the magnetic disturbance field.

Continuing in the method 400, block 716 may include generating a geomagnetic reference field based, at least in part, on the calculated localized magnetic crustal field. Then, at block 720, the method may include receiving a plurality of measured magnetic field values from the first vehicle for a plurality of locations arranged along a grid pattern.

The calculations performed in method 700 may be used in drilling into underground reservoirs. For example, the calculations performed in method 700 may include, at block 724, calculating a declination for subsea drilling based, at least in part, on the calculated localized magnetic crustal field. In particular, well placement by Measurement While Drilling (MWD) uses the direction of Earth's geomagnetic field as a natural reference direction. To compute the azimuth of the bottom hole assembly (BHA), the MWD tool takes a measurement of the magnetic field and the directional driller compares the measurement with the geomagnetic reference field. This requires accurate knowledge of the geomagnetic reference field direction and strength in the wellbore. The geomagnetic reference field calculated above may be used to obtain accurate mapping of a major contribution to the geomagnetic reference field in offshore locations, namely the crustal field.

Accurate wellbore positioning is particularly important in locating and producing resources in the Arctic region. The high latitudes associated with Arctic drilling pose a challenge to standard magnetic surveying techniques. Most notably, the accuracy of standard MWD surveys can be severely compromised by disturbance fields at high latitudes. The high-inclination limitation and the extensive time requirements of implementation limit the effectiveness of traditional gyroscopic surveys. An accurate and efficient solution is critical to the success of drilling in the Arctic environments. Geomagnetic referencing, using a geomagnetic reference field calculated as described above, provides this solution by simultaneously addressing the stringent well-placement requirements and the challenging surveying environment of Alaskan North Slope operations. The geomagnetic referencing has smaller Ellipses of Uncertainties (EOUs) than standard MWD, as such, the technique is capable of addressing the challenges to survey accuracy inherent in high-latitude drilling in the auroral zone. Geomagnetic referencing techniques with correction for high-disturbance components of Earth's magnetic field are particularly important when having to compensate for the effect of drillstring interference.

The magnetic measurements for the drilling calculations may be obtained in real-time with the drilling operation or in real-time with the receiving of magnetic fields at blocks 704 and 708. In some embodiments, the geomagnetic reference field is further calculated based on a set of localized magnetic crustal field measurements across the area to generate a geomagnetic reference field of the area (e.g., areas 232, 332, 432, 532, and 632 in FIGS. 2-6). In some embodiments of these methods, the first vehicle travels a path over a first area and the second vehicle travels a path over a second area, wherein the first area is larger than the second area and the first area at least partially encompasses the second area.

The method described with reference to FIG. 7 may be carried out by a processing station, located at the drilling site, the magnetic observatory, or another location; or via distributed computing systems situated at multiple locations. The processing station may include a memory for storing received magnetic measurements and other data and may include a processor coupled to the memory for executing the processing of the received magnetic measurements.

In some implementations of the calculations described above, magnetic measurements may be averaged over a time period, such as one minute, by an algorithm that is robust against outliers when down-sampling to 1 minute. The positional coordinates corresponding to the measurements can be averaged correspondingly. The average techniques may reduce aliasing in the measurements.

In some implementations of the calculations described above, occasional loss of a few minutes from the data stream can be avoided by implementing duplicate transmission for overlapping time windows. Alternatively or additionally, other known communication and wireless communication transmission techniques may be implemented in the radios attached to the AMVs.

In some implementations of the calculations described above, leakage of crustal anomalies into the time series of magnetic measurements can be reduced by having a prior crustal campaign to map an area, such as about a ten kilometer radius around the assigned location, using two vehicles.

In some implementations of the calculations described above recorded data may be preprocessed to ascertain that all survey lines are free of disturbances. Special attention may be paid to periods of magnetic storms. Any disturbed lines can then be resurveyed before the vehicles leave the survey area. A repeat survey may be performed following the same grid or with grid pattern with lesser or higher density to improve the accuracy as needed.

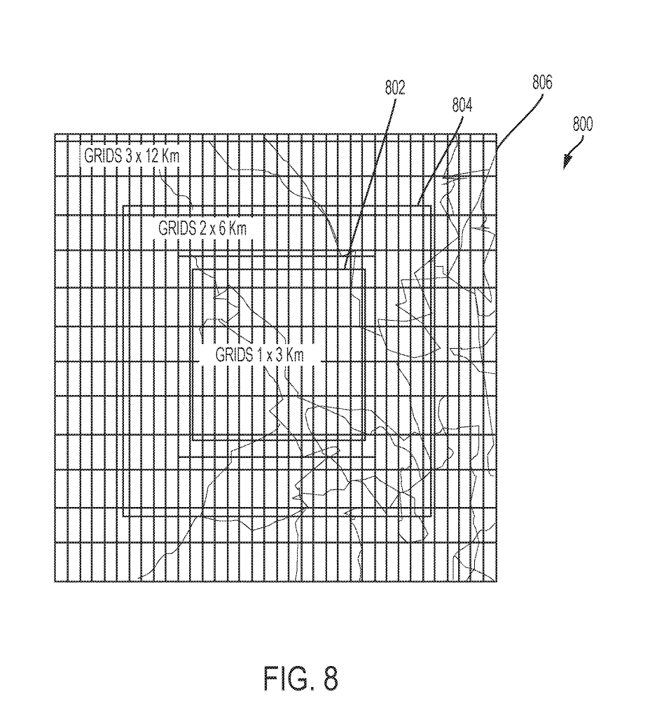

In one embodiment, a density of measurements may be varied throughout a region being scanned. The changing density of measurements may provide for different resolutions of measurements across a region. By decreasing and increasing resolution, an amount of time for scanning a region may be reduced by reducing resolution in regions of less interest. Further by decreasing and increasing resolution, an overall accuracy for the region may be improved by allowing increased resolution in regions of more interest. The different resolutions for various sub-regions may be selected based on possibility of anomalies present in the sub-regions based on other data, such as satellite data for the regions. One example of such a region is shown in FIG. 8. FIG. 8 is a map illustrating division of a region for scanning into sub-regions with different densities according to one embodiment of the disclosure. A region 800 for scanning may include several sub-regions, such as sub-regions 802, 804, and 806. A grid in the sub-region 802 may have measurements performed in 1×3 kilometer increments; a grid in the sub-region 804 may have measurements performed in 2×6 kilometer increments; and a grid in the sub-region 806 may have measurements performed in 3×12 kilometer increments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices or Cloud storage, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain of its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, from a first vehicle at a first location, a first set of magnetic field measurements corresponding to an area, wherein the magnetic field corresponds to measurements below a surface level;
receiving, from a second vehicle at an approximately stationary second location, a second set of magnetic field measurements for the second location, wherein the magnetic field corresponds to measurements below a surface level, and wherein the area is in the vicinity of the second location; and
calculating a localized magnetic crustal field based on the received first set of magnetic field measurements by subtracting the second set of magnetic field measurements from the first set of magnetic field measurements.

2. The method of claim 1, further comprising calculating a geomagnetic reference field based, at least in part, on the calculated localized magnetic crustal field.

3. The method of claim 1, further comprising receiving a plurality of measured magnetic field values from the first vehicle for a plurality of locations arranged along a grid pattern.

4. The method of claim 1, in which the step of calculating a localized magnetic crustal field comprises:
calculating a main field;
calculating a magnetic disturbance field; and
calculating the localized magnetic crustal field based on the main field and the magnetic disturbance field.

5. The method of claim 1, further comprising calculating a declination for subsea drilling based, at least in part, on the calculated localized magnetic crustal field.

6. The method of claim 1, in which the step of receiving the magnetic field comprises receiving the magnetic field in real-time.

7. The method of claim 1, wherein the geomagnetic reference field is further calculated based on a set of localized magnetic crustal field measurements across the area to generate a geomagnetic reference field of the area.

8. The method of claim 1, wherein the first vehicle travels a path over a first area and the second vehicle travels a path over a second area, wherein the first area is larger than the second area and the first area at least partially encompasses the second area.

9. A system, comprising:
a first vehicle comprising a first magnetic measurement device, the first magnetic measurement device configured to obtain a first magnetic measurement below a surface level wherein the first magnetic measurement device is attached to the first vehicle, and wherein the first vehicle is configured to monitor a first magnetic field at a first location;
a second vehicle comprising a second magnetic measurement device, the second magnetic measurement device configured to obtain a second magnetic measurement below a surface level wherein the second magnetic measurement device is attached to the second vehicle, and wherein the second vehicle is configured to monitor a second magnetic field at a second location;
a control system configured to provide the first vehicle and the second vehicle with data to control at least one of speed, heading, and waypoints; and
a processing system configured to receive the first magnetic measurement and the second magnetic measurement, wherein the processing system is further configured to calculate a localized magnetic crustal field based, at least in part, on the received first and second magnetic measurements by subtracting the second magnetic field measurement of the second magnetic measurement device from the first magnetic field measurement of the first magnetic measurement device.

10. The system of claim 9, wherein the processing system is further configured to generate a geomagnetic reference field based, at least in part, on the localized magnetic crustal field.

11. The system of claim 9, wherein at least one of the first vehicle and second vehicle comprises at least one of a meteorological, an oceanographic, and a bathymetric sensor.

12. The system of claim 9, wherein the control system further comprise a guidance system configured to provide waypoints along a grid pattern to the first vehicle.

13. The system of claim 9, wherein the processing system is configured to transmit the first and second magnetic measurements in real-time.

14. The system of claim 9, wherein the magnetic measurement device of the second vehicle is attached to the second vehicle by a tow wire.

15. The system of claim 9, in which the second vehicle further comprises at least one of a meteorological, an oceanographic, and a bathymetric sensor.

17. The system of claim 9, in which the second vehicle is configured to transmit the magnetic measurements in real-time.

18. The system of claim 9, in which the processing system is further configured to perform the steps of:
calculating a main field;
calculating a magnetic disturbance field; and
calculating the localized magnetic crustal field based on the main field and the magnetic disturbance field.

19. An apparatus, comprising:
a memory; and
a processor coupled to the memory, wherein the processor is configured to execute the steps of:
receiving, from a first vehicle at a first location, a first set of magnetic field measurements corresponding to an area, wherein the magnetic field corresponds to measurements below a surface level;
receiving, from a second vehicle at an approximately stationary second location, a second set of magnetic field measurements for the second location, wherein the magnetic field corresponds to measurements below a surface level, and wherein the area is in the vicinity of the second location; and
calculating a localized magnetic crustal field based on the received first set of magnetic field measurements by subtracting the second set of magnetic field measurements from the first set of magnetic field measurements.

20. The apparatus of claim 19, wherein the first set of magnetic field measurements comprise a first sub-set of magnetic field measurements in a first sub-region of the area at a first resolution and a second sub-set of magnetic field measurements in a second sub-region of the area at a second resolution.
